(19) United States
(12) Patent Application Publication
(10) Pub. No.: US 2023/0316410 A1
(43) Pub. Date: Oct. 5, 2023

(54) DUAL TELEMETRY SYSTEM AND METHOD TO REDUCE INSURANCE COSTS AND CLAIMS FOR VEHICLES DRIVEN FULLY OR PARTIALLY FOR COMMERCIAL PURPOSES

(71) Applicant: Ago Technologies LLC, Middletown, DE (US)

(72) Inventors: Krishnan Padmanabhan, Palo Alto, CA (US); Jeremy Spoon, Munster, IN (US); Ryan Murphy, St. Louis, MO (US); Derek Smith, New York, NY (US)

(21) Appl. No.: 18/128,351

(22) Filed: Mar. 30, 2023

Related U.S. Application Data
(60) Provisional application No. 63/325,916, filed on Mar. 31, 2022.

(51) Int. Cl. G06Q 40/08

(52) U.S. Cl. CPC G06Q 40/08

(57) ABSTRACT

An integrated system and method to minimize insurance costs and mobility risk for individual commercial drivers, fleet owners, and insurance companies through continuous vehicle telemetry monitoring and commercial trip data collection, to assess driver/vehicle economics and safety, and to provide driver feedback and incentives that alter their behaviors to minimize insurance costs and reduce accident risk.

### CROSS-REFERENCE TO RELATED APPLICATIONS

This patent application claims the benefit under 35 U.S.C. § 119(e) of U.S. Provisional Patent Application No. 63/325,916 filed on Mar. 31, 2022 titled “Integrated system and method to minimize insurance costs and mobility risk for individual commercial drivers, fleet owners, and insurance companies through continuous vehicle telemetry monitoring and commercial trip data collection, to assess driver/vehicle economics and safety, and to provide driver feedback and incentives that alter their behaviors to minimize insurance costs and reduce accident risk”, which application is incorporated herein by reference.

### BACKGROUND OF THE INVENTION

### Field of the Invention

This invention relates generally to driver risk assessment systems, in particular to an Integrated System and Method for minimizing insurance costs, improving the economics of driver mobility, and lowering accident risk by acquiring and analyzing “Dual Telemetry” (vehicle telemetry and driver commercial trip histories) to assess differing insurance coverage during distinct commercial trip time periods, computing corresponding miles driven during those time periods, and distributing the risks and associated insurance costs commensurate with the mileage breakouts among various parties, including commercial platforms, fleet owners, and drivers. Additionally, to further assess insurance risks and costs, especially during periods not covered by commercial platform insurance, the Integrated System and Method monitors vehicle telemetry to assess risky driving.

The Integrated System and Method closes the feedback loop with “driver nudging” using real-time and short-delay messaging, incentives, and dynamic mobility pricing recommendations and/or changes, aiming to lower near-term insurance premiums by encouraging drivers to drive fewer miles not covered by commercial platform insurance and to reduce future insurance costs via safer driving.

The overall goal of the Integrated System and Method is improving mobility economics by enabling real-time understanding of insurance costs and risks and providing feedback to drivers that incentivize behavior changes that minimize insurance premium costs and accident risks.

### Description of Related Art

Assessment of driver risk by monitoring driver behaviors has expanded substantially in recent years. Most approaches involve continuous monitoring of driver behavior, assessing attributes such as speeding, braking, acceleration, and driving while tired (“tired driving”). An example is U.S. Pat. No. 10,482,688 (“System and method for driver risk assessment through continuous performance monitoring”).

However, dynamically parsing risk among parties is not broadly available. As a result, many commercial drivers and fleet owners who rent to commercial drivers double-pay for insurance due to the inability to determine which miles are insured by commercial platforms and which miles are not insured by commercial platforms. Personal and fleet insurance policies typically cover all miles driven by vehicles despite coverage from commercial platforms during periods when the driver is working for such platforms.

Some commercial platforms attempt to address the double insurance problem with clauses stating that a driver's or fleet owner's insurance holds first liability in the event of a claim and that the commercial platform's insurance provides coverage only to the extent that the driver's or fleet owner's insurance falls short. On the driver and fleet owner side, insurance policies give little or no price reduction to reflect miles that are insured by commercial platforms. As a result, there is an opportunity to significantly optimize the provision of insurance to commercial-centric drivers and fleet owners if the fraction of miles driven that are commercial platform insured is known.

### SUMMARY OF THE INVENTION

It is the object of the present invention to provide an Integrated System and Method for Insurance Optimization via “Dual Telemetry” collection and analysis of: (1) vehicle telemetry that enables calculation of miles driven between any two times and assessment of unsafe driving behaviors, and (2) driver commercial trip history (“trip telemetry”). The Integrated System and Method is configurable to use multiple methods for collecting vehicle and trip telemetry.

The Integrated System and Method uses said Dual Telemetry to produce reports showing the breakout of miles driven under each insurance coverage scenario, including but not limited to total miles insured by each commercial platform for liability, total miles insured by each commercial platform for physical damage, and total miles not insured by any commercial platform for liability and/or physical damage that need to be insured by the driver or fleet owner. The Method can report insured vs. uninsured mileage totals from driver-centric, vehicle-centric, and fleet-centric viewpoints.

The term “commercial platform” in the above context refers to any insurance coverage that is available when a driver or vehicle is performing mobility services for any organization, including but not limited to platforms that offer insurance such as ride sharing services, grocery delivery services, package delivery services, food delivery services, ambulatory services, elderly transport services, and any other commercial platform that contracts for mobility services and offers associated insurance coverage. In this context, “commercial platform” insurance coverage includes risk sharing agreements among organizations, individuals, and organizations and individuals that may not have explicit insurance coverage agreements.

The Integrated System and Method uses said Dual Telemetry to assess overall insurance costs for each driver and vehicle, assess overall mobility economics, and dynamically update both messaging to drivers and mobility pricing to incentivize drivers to minimize miles driven with no commercial platform insurance coverage, thus minimizing driver and/or fleet insurance costs and optimizing overall mobility economics.

The Integrated System and Method also monitors additional elements of vehicle telemetry such as speeding, braking, acceleration, tired driving, and late-night driving. The Method analyzes this telemetry to produce an overall driver Risk Score, as well as Risk Scores during various driving periods insured by different parties, and uses these Risk Scores to further adjust driver messaging and mobility pricing to incentivize drivers to minimize unsafe driving behaviors and thus further lower insurance costs via reduced accident risk.

### BRIEF DESCRIPTION OF THE DRAWINGS

FIG. 1 is a schematic flowchart of the Integrated System and Method.

FIG. 2 is a table of sample vehicle miles driven during a specified time period based on vehicle odometer readings.

FIGS. 3a and 3b is a sample timeline of commercial trip periods for two sequential trips where “P1” means Period 1, “P2” means Period 2, etc.

FIG. 4 defines the various commercial trip periods and shows insurance coverage provided by sample commercial platforms during different trip periods as shown in FIG. 3.

FIGS. 5a and 5b are a sample table of commercial account registrations with Trip Telemetry connection status, where “error_code” indicates whether a driver's commercial platform credentials are or are not enabling successful retrieval of that driver's commercial trip history.

FIGS. 6a and 6b are a table of sample commercial trips for a specific driver with start/end times for various periods during each commercial trip and calculated miles driven that are fully (liability and physical damage) or partially (liability only) insured by a commercial platform(s).

FIG. 7 is a schematic showing overlap elimination between two sequential overlapping commercial trips.

FIGS. 8a and 8b shows an illustrative fleet reservation table showing which drivers are driving specific vehicles during various time periods. ShiftStart and ShiftEnd are the officially reserved reservation start/end times. ShiftActivate and ShiftClose are the actual vehicle pickup and drop-off times determined from analysis of vehicle telemetry and/or other records.

FIGS. 9a and 9b show a table summary of vehicle miles driven for various commercial platforms during a specified period for several drivers.

FIGS. 10a and 10b show table summary of vehicle miles driven for various commercial platforms during a specified period for several vehicles.

FIGS. 11a and 11b are a sample table summary of miles driven during a specified period showing liability and physical damage premium assessments per driver.

FIGS. 12a and 12b are a sample table summary of miles driven during a specified period showing liability and physical damage premium assessments per vehicle.

FIG. 13 is a summary report of fleetwide total insurance costs and commercial vs. non-commercial insured miles during specified period.

FIG. 14a is a simplified visual representation of the Integrated Dual Telemetry System and Method to reduce insurance costs and claims for vehicles driven fully or partially for commercial purposes.

FIGS. 14b, 14c, and 14d illustrate the product of the Integrated Dual Telemetry System and Method which is an insurance bill that shows fleetwide total miles driven, the breakout of miles between commercial (“gig”) miles insured for liability and/or physical damage, commercial (“gig”) miles not insured for liability and/or physical damage, and personal miles driven while not operating for a commercial platform. Also shown are the resulting premiums for liability and physical damage insurance, but before and after adjustment for driving safety.

FIGS. 15a and 15b are a sample table showing driver economics.

FIG. 16 shows a driver smartphone application screen that displays how mobility (i.e., vehicle rental) price is affected by commercial vs. non-commercial insured miles driven and unsafe driving behaviors.

FIGS. 17a and 17b show pricing messages sent to drivers based on their insurance costs derived from Dual Telemetry analysis of commercial platform insured vs. not commercial platform insured miles driven.

FIG. 18 shows fleetwide tracking of percentage of miles that are not insured by a commercial (i.e., “gig”) platform and can be used to assess the effectiveness of mobility pricing and messaging to drivers.

FIGS. 19a and 19b are a sample table of fleetwide unsafe driving behaviors and events showing both the total number of such events during each time period and the number of such events relative to both miles driven and hours of vehicle operation.

FIG. 20 shows a summary of illustrative Risk Points assigned to various types of potentially unsafe driving behaviors.

FIGS. 21a and 21b show a sample table of driver Risk Points based on vehicle telemetry analyzed for tired driving, speeding, hard braking, hard acceleration, and late-night driving and scored relative to miles driven and hours of vehicle operation.

FIG. 22 is a sample table of pricing messages sent to drivers citing their unsafe driving behaviors derived from vehicle telemetry analysis.

FIG. 23a shows a histogram of driver Risk Points per 100 miles driven.

FIG. 23b shows a histogram of driver Risk Points per 100 vehicle operating hours.

FIG. 24 is a graphical representation of fleetwide tracking of a specific unsafe driving behavior (in this case, speeding) and can be used to assess the effectiveness of mobility pricing and driver messaging.

FIG. 25 summarizes the Dual Telemetry value proposition and shows different types of customer beneficiaries.

### DETAILED DESCRIPTION OF PREFERRED EMBODIMENTS

The following description enables any person skilled in the arts of API integration, data analysis, insurance risk, and mobility operations to implement the Integrated System and Method described herein. Modifications and improvements to this Integrated System and Method will be readily apparent to those skilled in such arts.

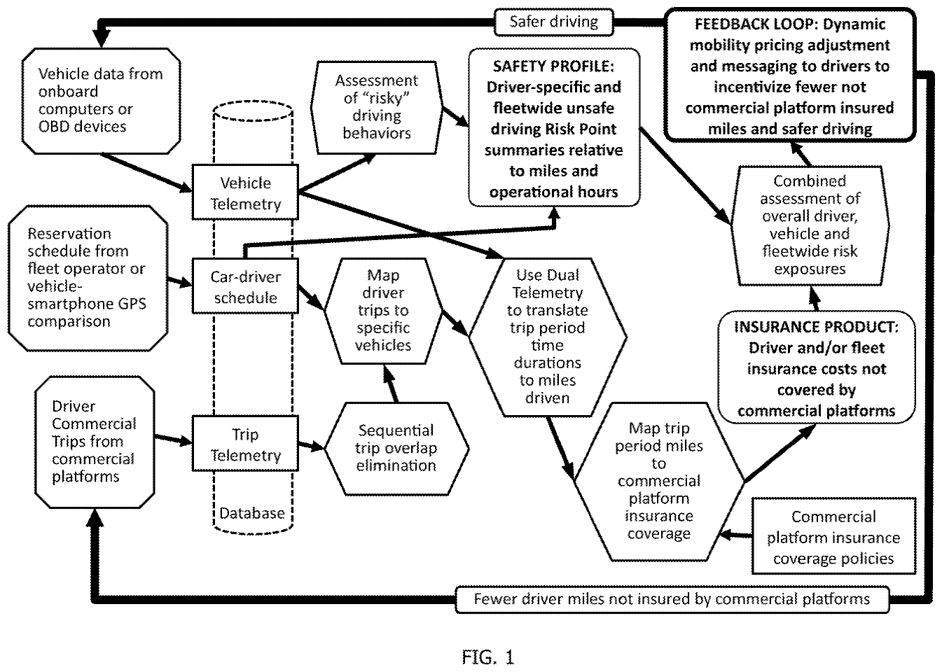

FIG. 1 is a visual representation of the Integrated System and Method that uses “Dual Telemetry” to understand driver risk by analyzing total miles driven, miles driven for various commercial platforms, and unsafe driving behaviors to produce an optimized insurance product for commercial fleets and drivers and to lower risk exposures via pricing and messaging feedback to drivers intended to alter driving behaviors. Dual telemetry is the combination of “vehicle telemetry” (odometer, GPS, speed, braking, acceleration, ignition status, and other data obtained directly from vehicle onboard computers or via devices such as OBD port GPS-enabled mileage trackers), supplemented with GPS-capable smartphone telemetry as needed, and “Trip telemetry” (driver commercial trip histories). The Car-Driver Schedule translates commercial trip period start/end times into miles driven during each period, which requires knowing which driver is in each vehicle at the relevant times. The Car-Driver Schedule is supplemented by analyzing the geographic correlation between GPS-capable smartphone telemetry and vehicle GPS telemetry which, if coincident, imply a specific driver is in a specific vehicle. Trip Telemetry refers to the history of a driver's commercial trips. Dual Telemetry is the combination of Vehicle Telemetry and Trip Telemetry.

Dual Telemetry enables calculation of miles driven by each driver and vehicle during various periods of each commercial trip. The Integrated System and Method uses Dual Telemetry data to produce a report of commercial miles driven on each commercial platform for each vehicle and driver by feeding into the user's data from the commercial engagement. This report enables minimization of insurance costs by tracking miles driven that are insured by commercial platforms and thus do not require insurance premium payments from drivers or fleet owners.

Vehicle telemetry analysis of risky driver behaviors enables the Integrated System and Method to further reduce insurance costs via lowered accident risk during various periods of commercial and personal vehicle operation. Vehicle telemetry provides a continuous stream of driver behavior indicators such as speeding, braking, acceleration, tired driving, and late-night driving that the Method analyzes to assess driver accident risks. From a fleet operator's and/or commercial driver's perspective, risky driving during miles driven that are not insured by a commercial platform pose the highest risk.

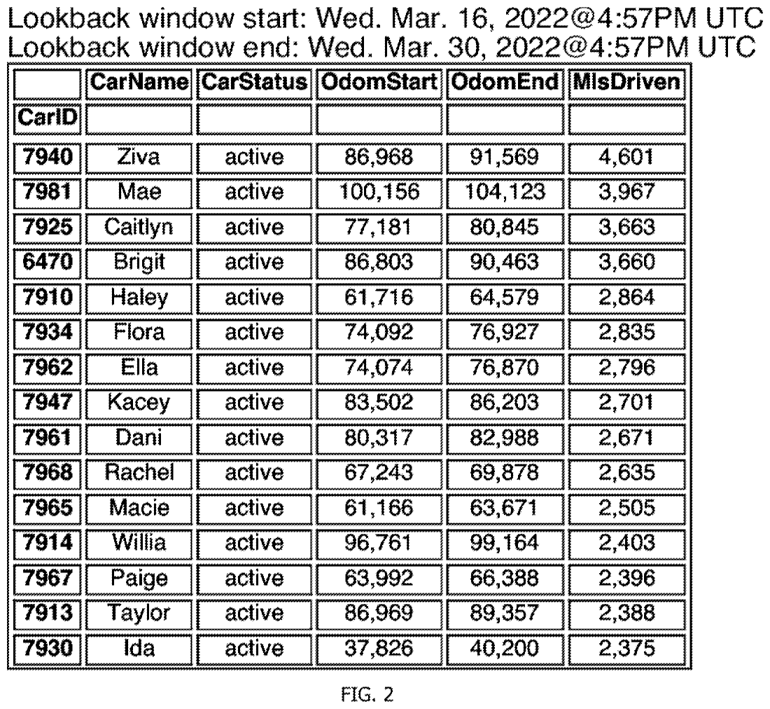

FIG. 2 shows vehicle odometer data between two specified times of the type that connected vehicles typically transmit. Other sources of data that enable calculation of vehicle miles driven between specified times are devices such as OBD port GPS-enabled mileage trackers or GPS-capable smartphones. In the absence of odometer vehicle telemetry, miles driven between any two times can be calculated from GPS data by calculating the distance between each sequential GPS data point collected during the time interval of interest and summing those distances.

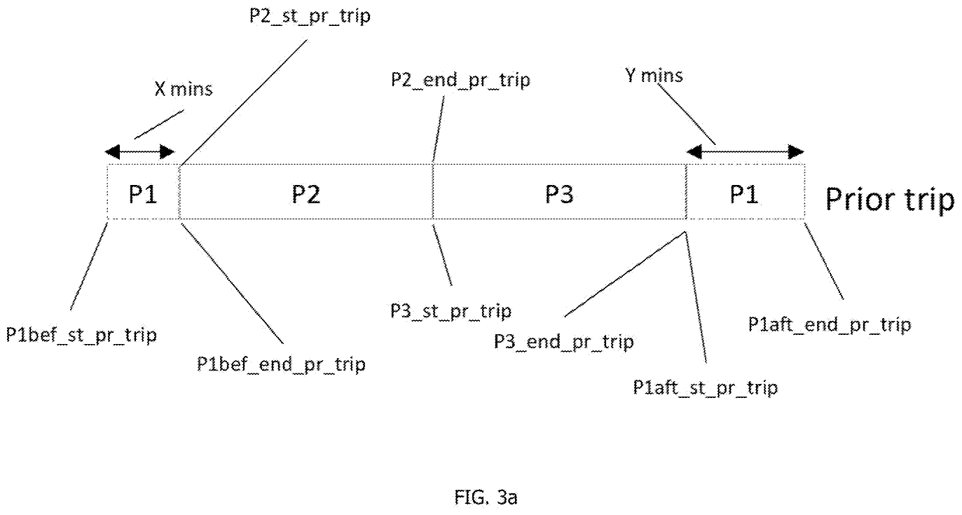

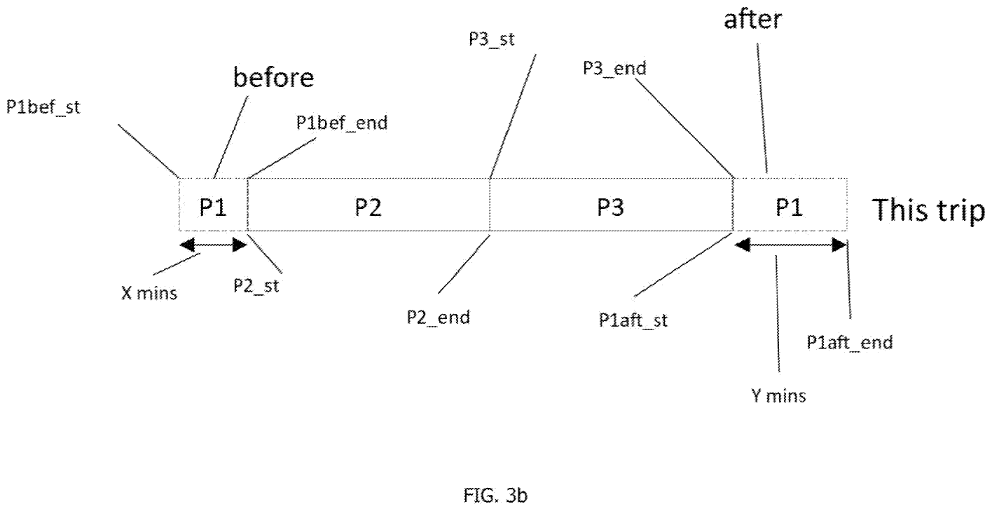

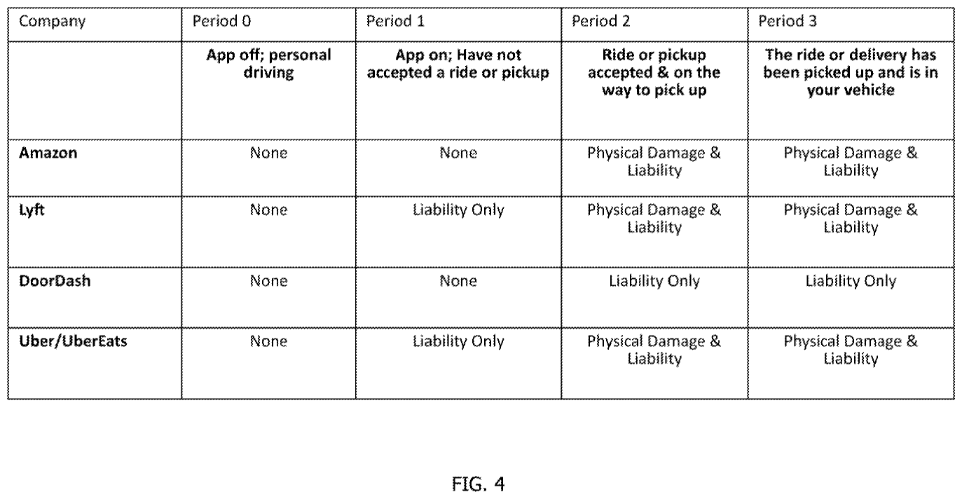

FIGS. 3a and 3b show the typical way commercial trips are broken into periods for sequential trips that do not overlap. FIG. 4 shows example insurance coverages provided by commercial platforms during the periods referenced in FIG. 3. In particular, FIG. 4 shows that different commercial platforms provide differing combinations of insurance coverage during the various periods of a commercial trip. Thus, if the miles driven during each commercial trip period can be calculated, it is possible to determine total miles insured by each commercial platform for liability, total miles insured by each commercial platform for physical damage, and total miles not insured by any commercial platform that should thus be insured by the driver or fleet owner.

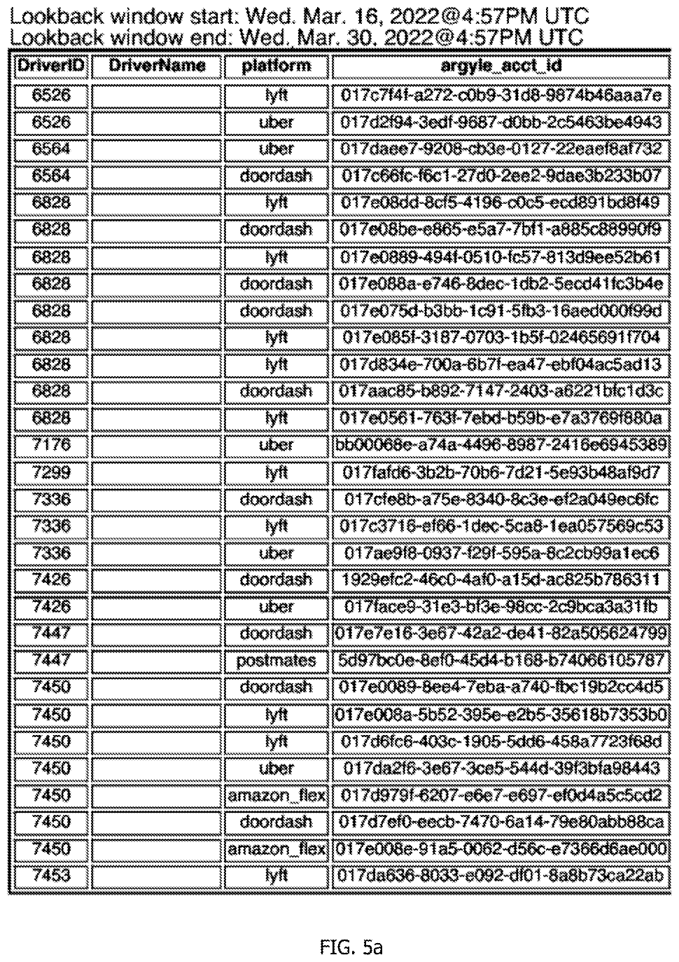

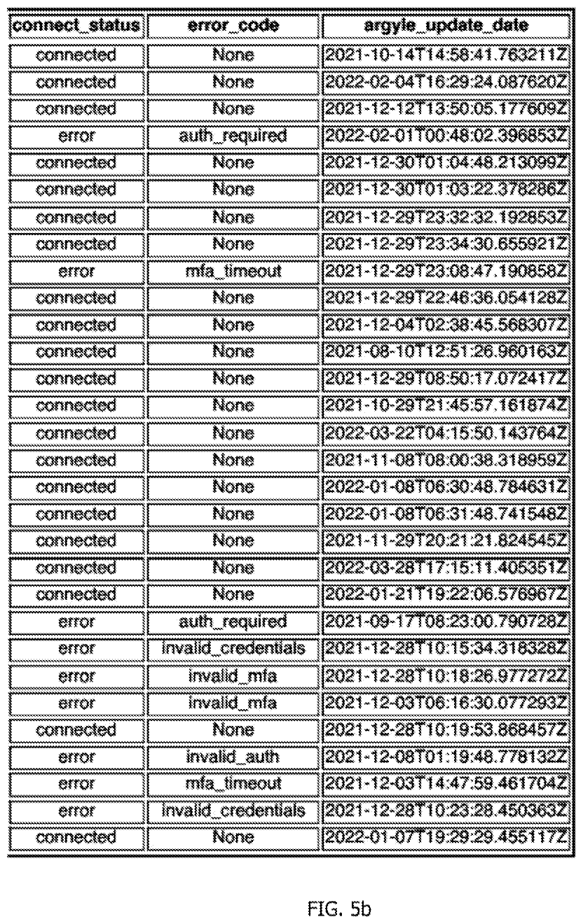

To calculate miles driven during various periods for each driver commercial trip, drivers must register their commercial account credentials so that the Integrated System and Method can capture driver commercial trip histories. FIGS. 5a and 5b show typical driver commercial account registrations with connection status which the Integrated System and Method uses to determine which drivers are reporting commercial trips, and which are not, so that actions may be taken to encourage all drivers to register their commercial account credentials.

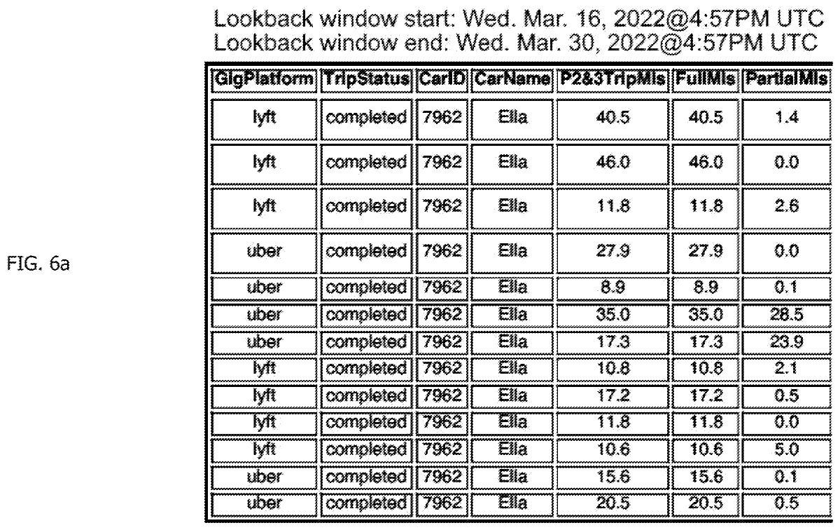

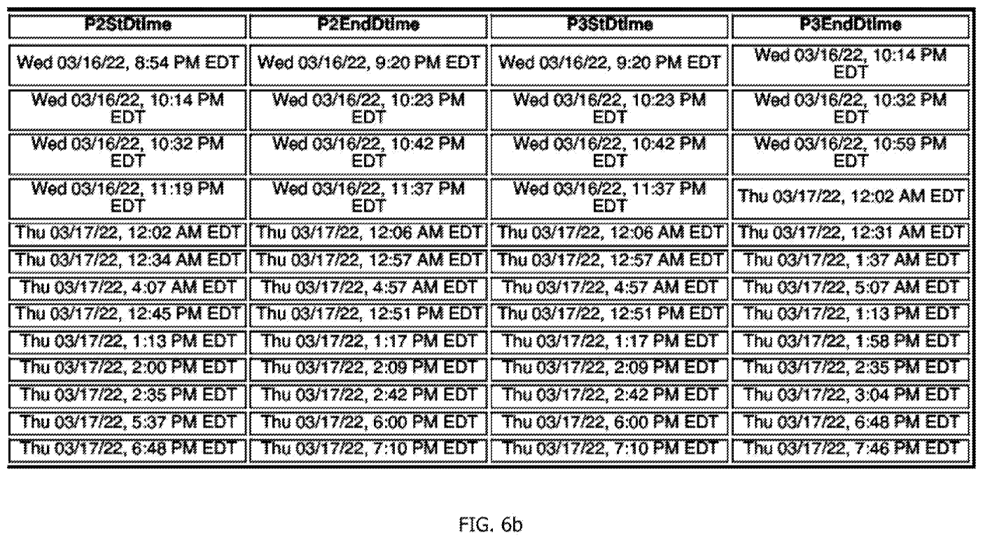

FIGS. 6a and 6b shows a sample commercial trip history for a specific driver with start/end times for various periods during each commercial trip and calculated miles driven that are fully (liability and physical damage) or partially (liability only) insured by a commercial platform(s). Commercial drivers sometimes start a new commercial trip before ending the previous commercial trip to maximize earnings. Commercial trip overlap can occur on one commercial platform, for example, by accepting a new rideshare passenger before dropping off the existing rideshare passenger, or across different commercial platforms, for example, by delivering food while simultaneously transporting a rideshare passenger.

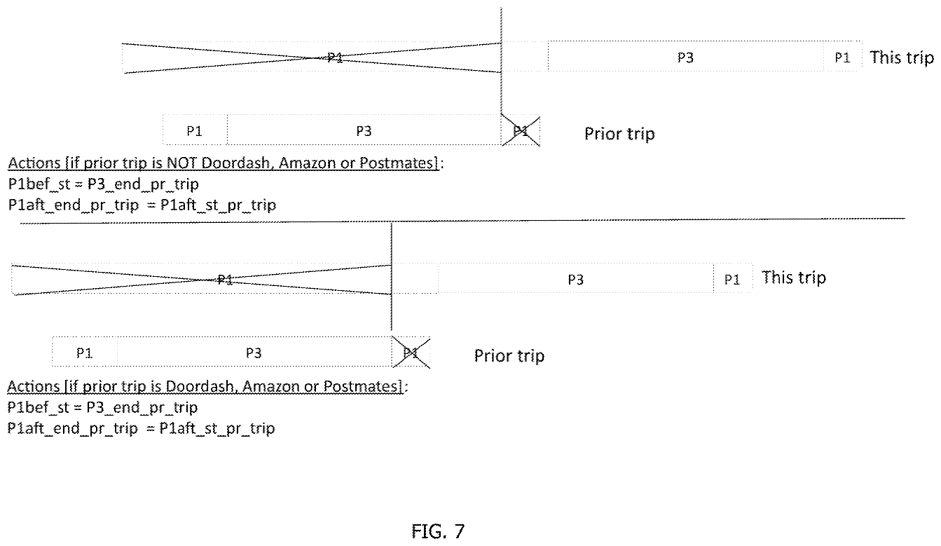

FIG. 7 shows the typical nomenclature of the periods within two sequential overlapping commercial trips. For the purposes of determining miles insured by various commercial platforms, it is important not to double-count commercial insurance coverage (i.e., not to claim the same mile is insured by two different commercial platforms and thus have an inflated total for commercial platform insured miles).

FIG. 7 shows two sequential commercial trips that overlap and algorithmic methodology for eliminating such overlap to avoid double-counting commercial platform insured miles. As shown, overlap is typically eliminated in a way that retains the better mobility insurance coverage. For example, if there is an overlap between periods in two sequential commercial trips and the overlapping part of the period for the first commercial trip provides only liability coverage, whereas the overlapping part of the period for the second commercial trip provides liability and physical damage coverages, the overlapping part of the period for the second commercial trip will be retained and the overlapping part of the period from the first commercial trip will be eliminated. There are many permutations and combinations for a driver's sequential commercial trips to overlap, and the System and Method identifies all these overlap permutations and combinations and eliminates sequential commercial trip overlaps optimally. Translating commercial trip period start/end times into miles driven during each period requires knowing which driver was driving each vehicle during said periods to match commercial trips for a specific driver to a specific vehicle.

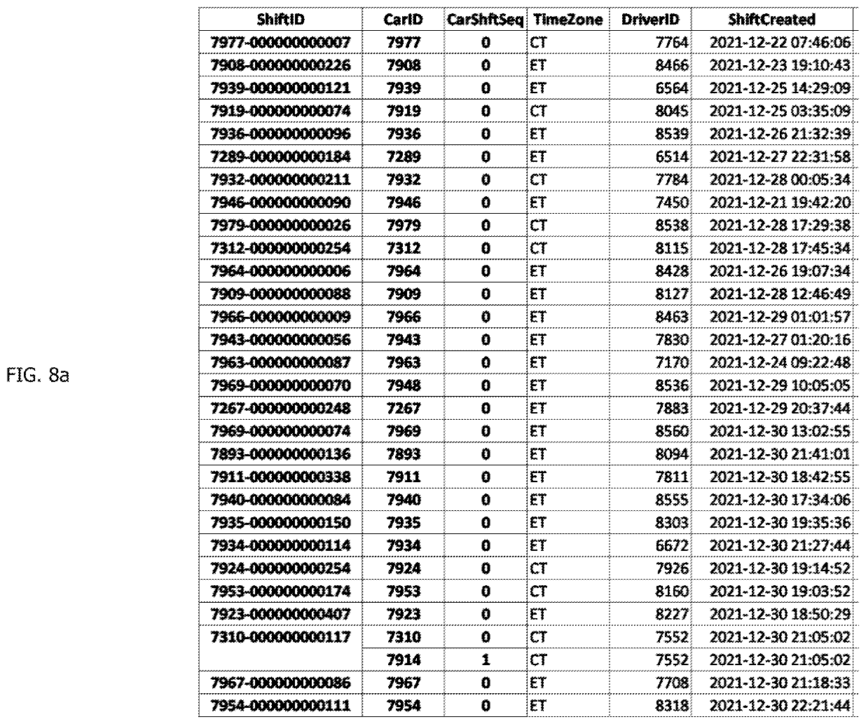

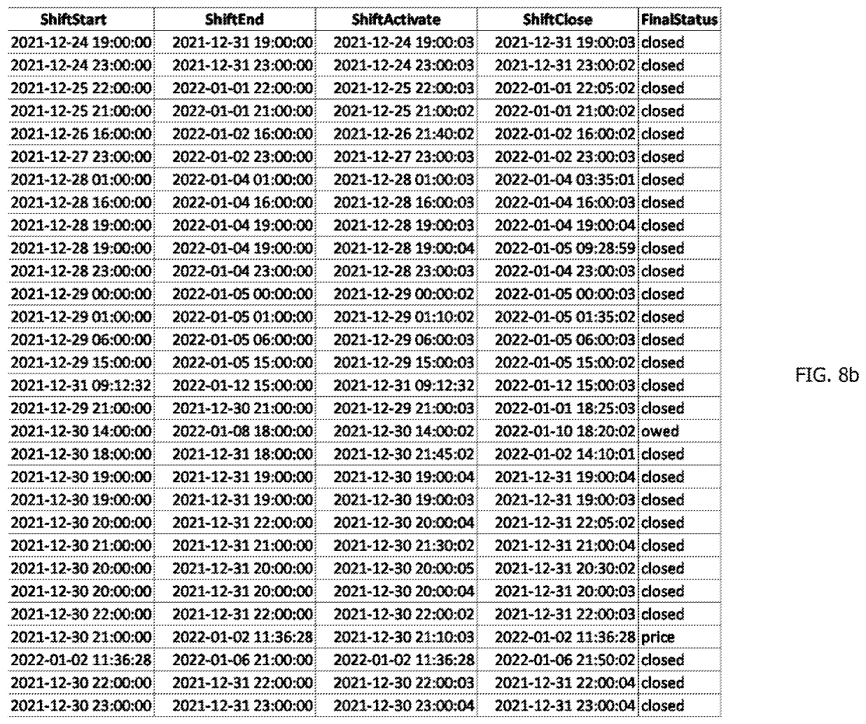

FIGS. 8a and 8b show a typical vehicle reservation record with each reservation having a specified vehicle, driver, and start/end times. The Integrated System and Method assesses miles driven using two different kinds of start/end times: officially reserved times based on what the driver booked, and actual vehicle pickup and drop-off times as determined by vehicle telemetry and/or other records.

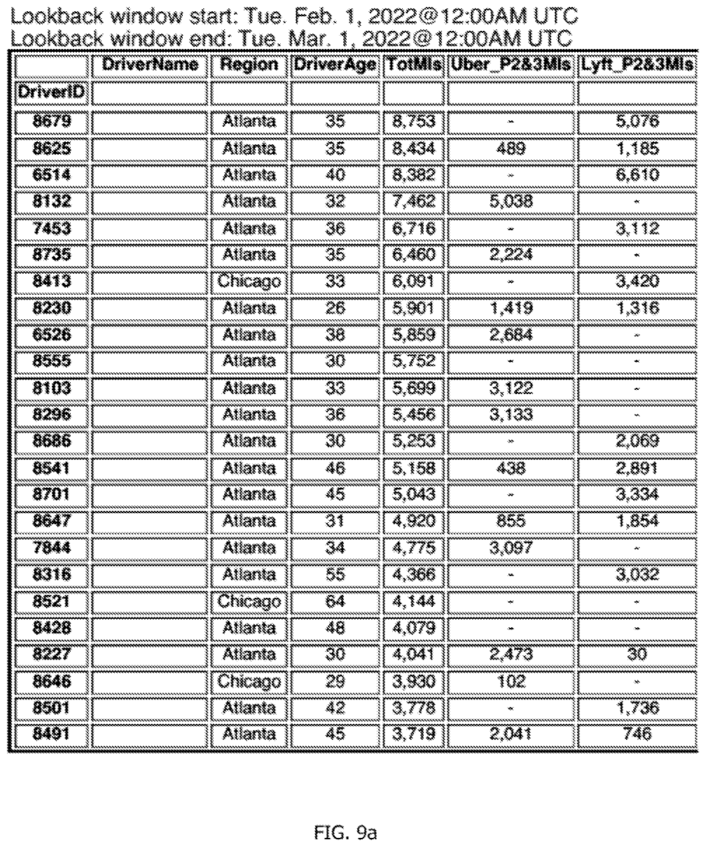

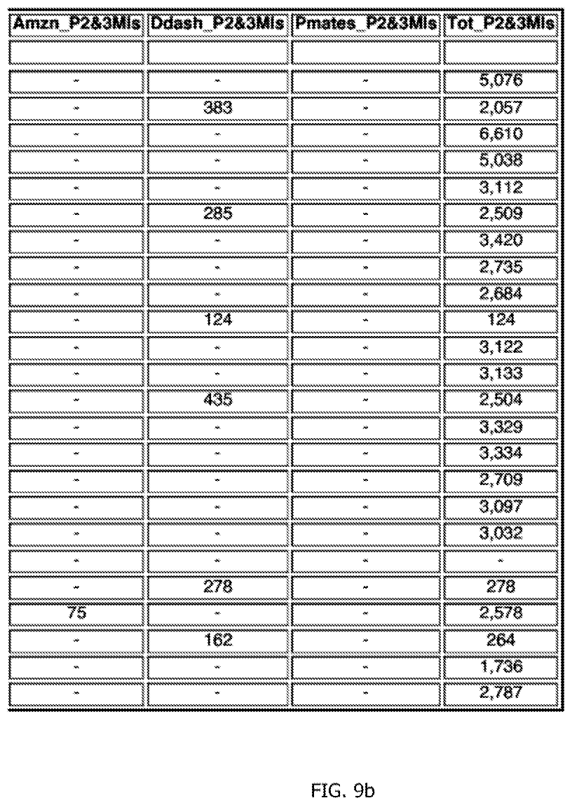

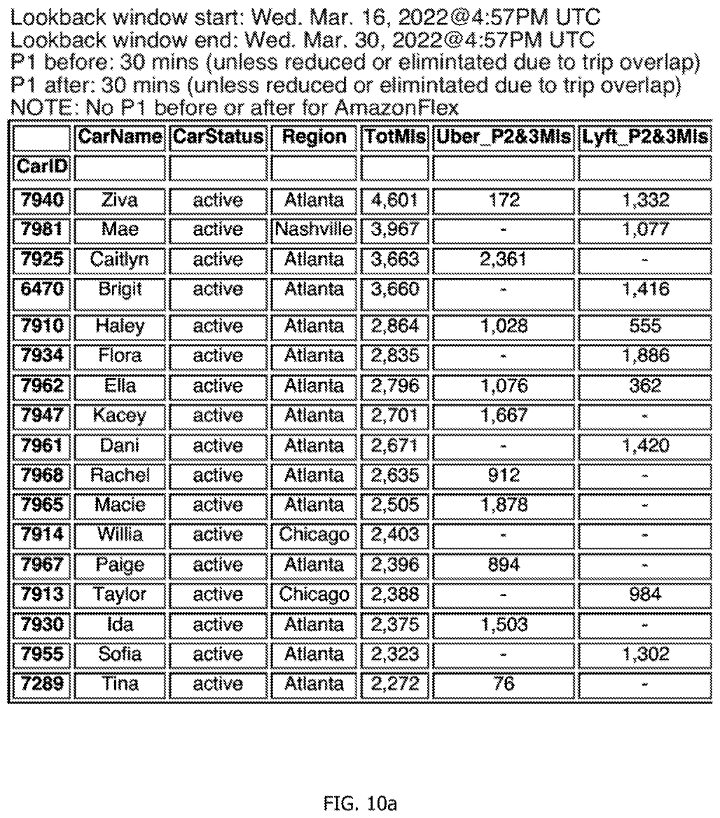

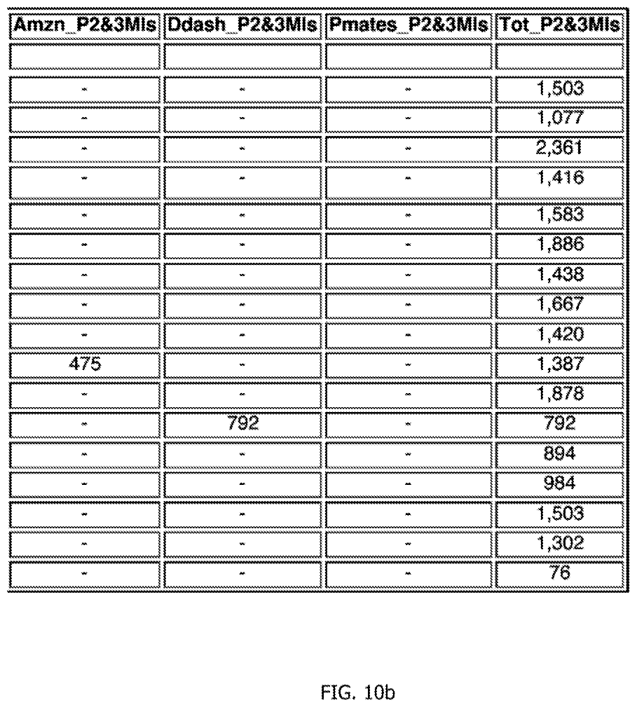

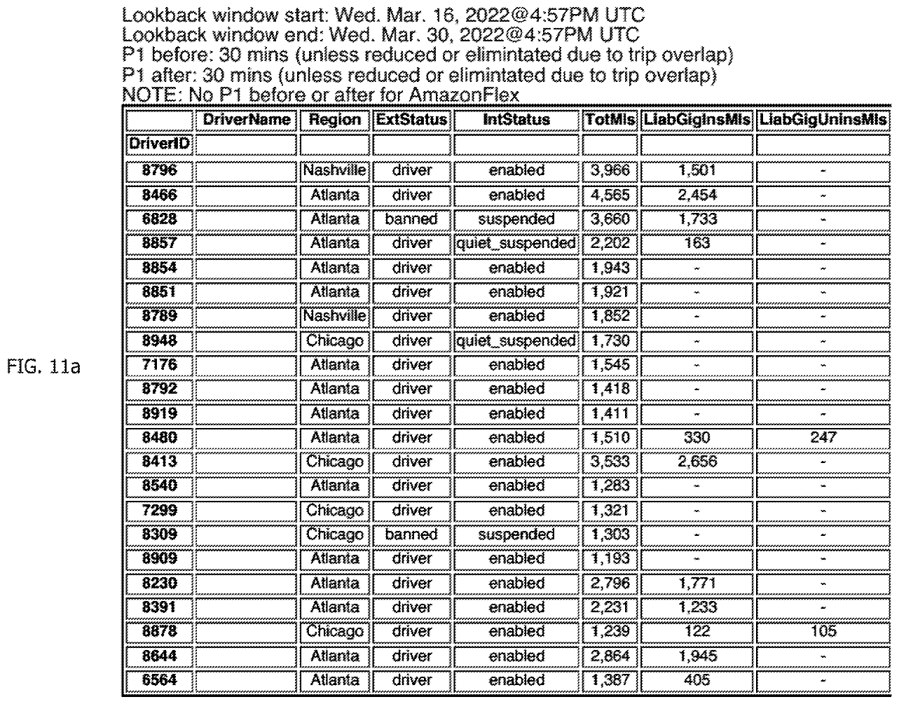

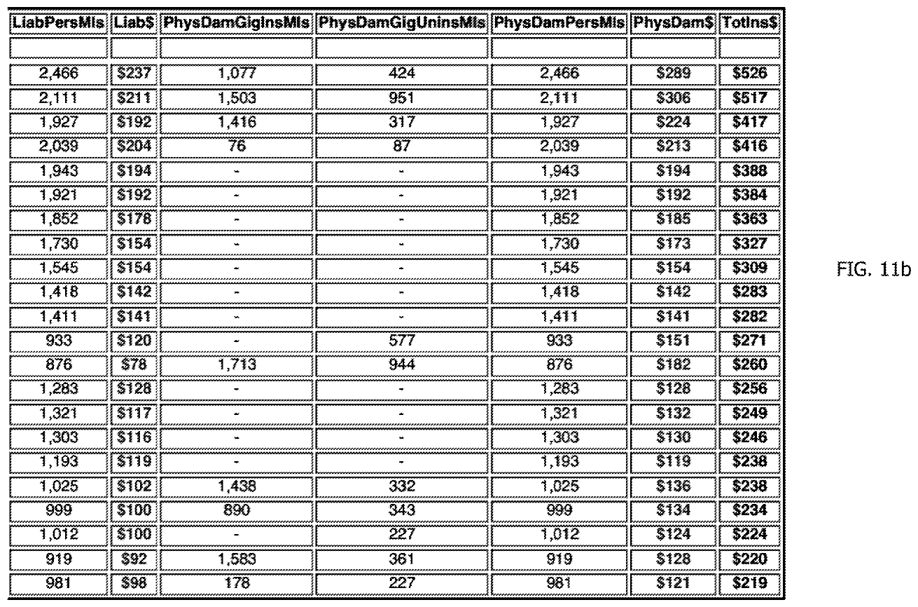

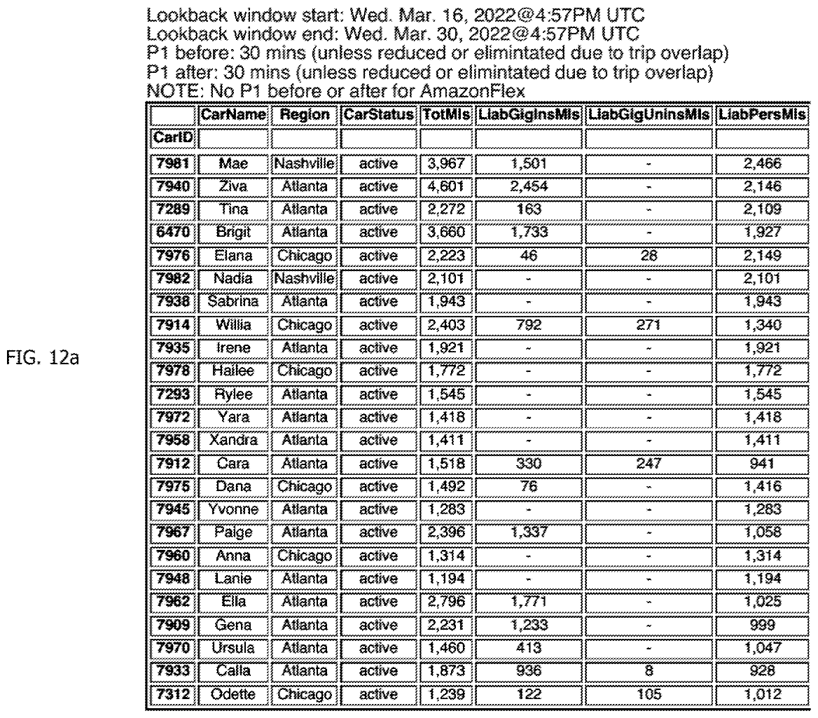

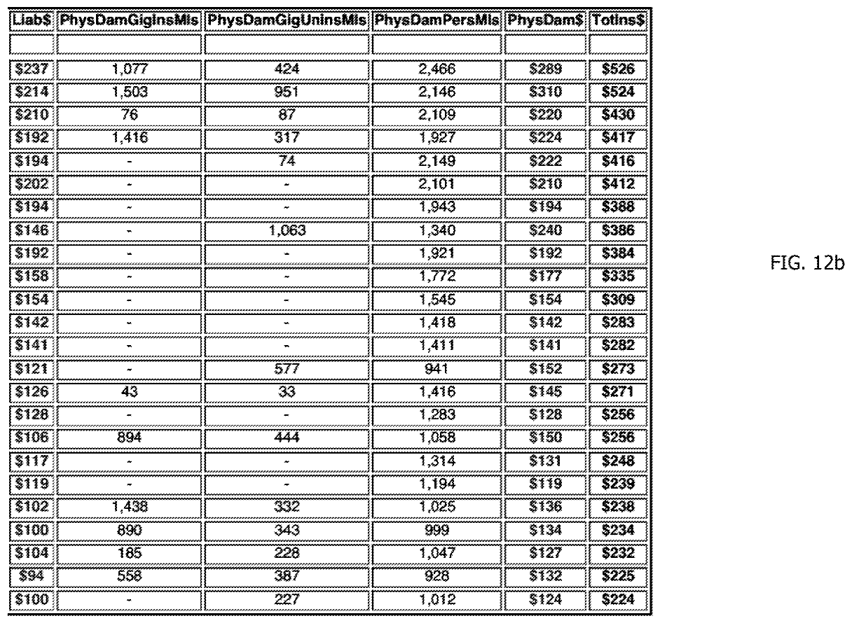

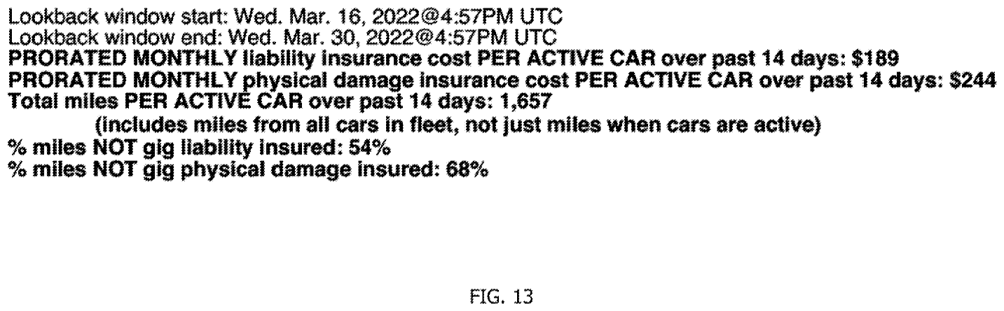

As shown in FIGS. 9a, 9b, 10a, and 10b, once drivers are mapped to vehicles during specified times, trip miles on each commercial platform can be calculated for each driver and vehicle. Using the differing insurance coverages for each commercial platform, illustratively shown in FIG. 4, FIGS. 11a, 11b, 12a, and 12b show total miles driven, commercial miles that are and are not insured for liability, commercial miles that are and are not insured for physical damage, and personal miles (i.e., miles not driven for or insured by any commercial platform) and resulting insurance liability and physical damage insurance costs for each driver and vehicle can be calculated. FIG. 13 shows overall miles that are and are not commercial platform insured summarized at a fleet level.

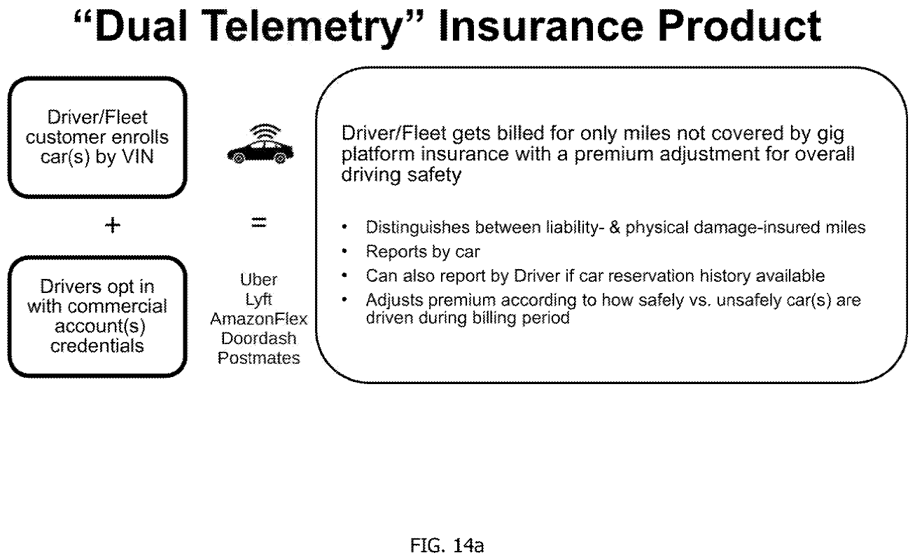

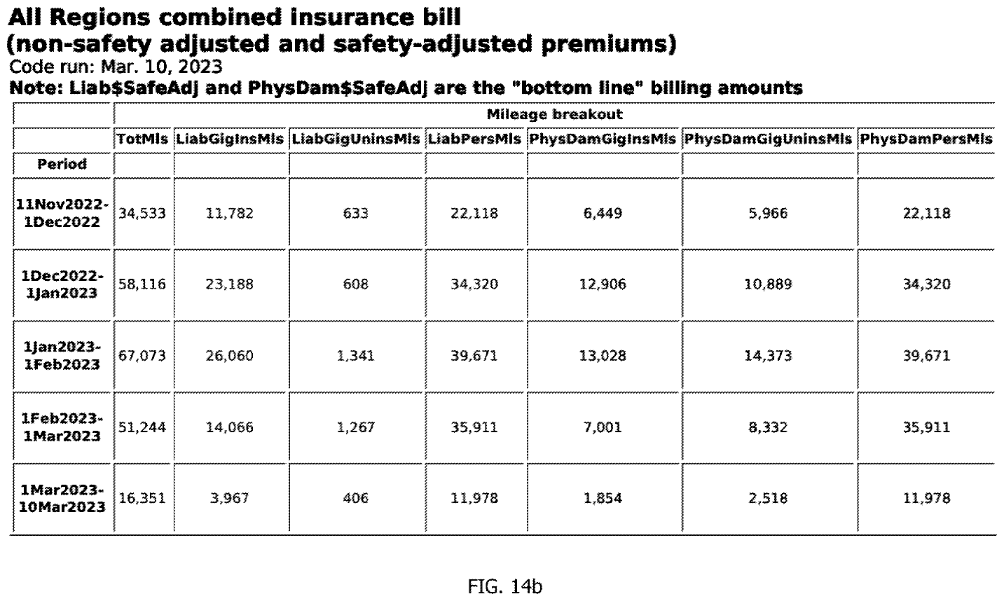

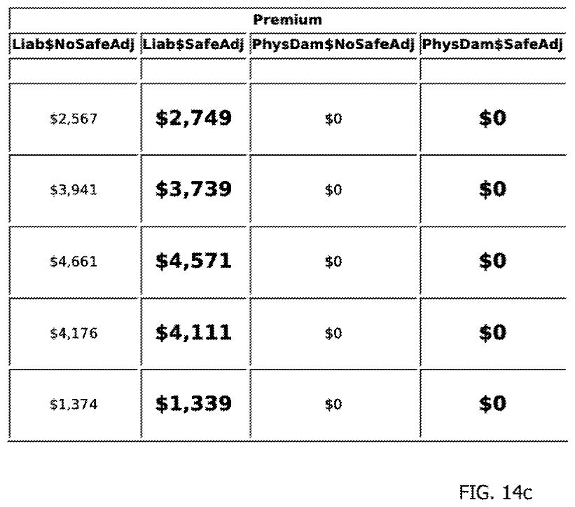

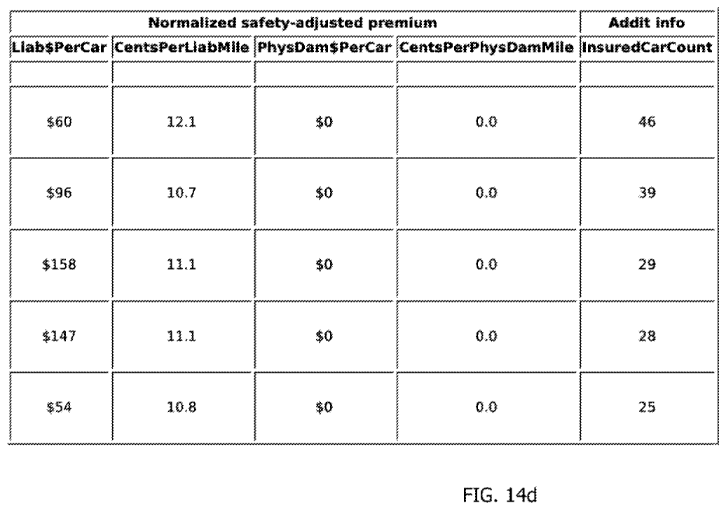

Once total miles insured by each commercial platform for liability, total miles insured by each commercial platform for physical damage, and total miles not insured by any commercial platform are calculated for each driver and vehicle, an overall insurance report for each driver and/or fleet owner can be calculated, as illustrated in FIGS. 14a through 14d. This report is a Dual Telemetry insurance product and, assuming that insurance is sold on a “per mile” or “per vehicle operating hour” basis, contains monetary liability and physical damage insurance premium costs for each driver and vehicle for a specified period. The fleet owner's and/or driver's premiums for miles not covered by a commercial platform can be adjusted for the safety with which vehicle(s) are driven. A legend of the column titles in FIGS. 14b-14d is provided below:

| | |
|---|---|
| TotMIs: | Sum of all miles driven |
| LiabGigInsMIS: | Sum of gig miles driven that are insured for |
| | liability by a gig platform |
| LiabGigUninsMIs: | Sum of gig miles driven that are NOT insured |
| | for liability by a gig platform. Assumes 1.1x |
| | liability insurance rate uplift |
| LiabPersMIs: | Sum of non-gig miles driven which by |
| | definition are not insured for liability by a |
| | gig platform |
| Liab$NoSafeAdj: | Liability premium NOT factoring in driver |
| | safety |
| Liab$SafeAdj: | Liability premium after adjusting |
| | Laib$NoSafeAdj for driver safety |
| PhysDamGigInsMIs: | Sum of gig miles driven that are insured for |
| | physical damage by a gig platform |
| PhysDamGigUninsMIs: | Sum of gig miles driven that are NOT insured |
| | for physical damage by a gig platform. |
| PhysDamPersMIs: | Sum of non-gig miles driven which by |
| | definition are not insured for physical |
| | damages by a gig platform |
| PhysDam$NoSafeAdj: | Physical damage premium NOT factoring in |
| | driver safety |
| PhysDam$SafeAdj: | Physical damage premium after adjusting |
| | PhysDam$NoSafeAdj for driver safety |
| Liab$PerCar: | Average safety-adjusted liability premium per |
| | insured car this period |
| PhysDam$PerCar: | Average safety-adjusted physical damage |
| | premium per insured car this period |
| CentsPerLiabMile: | Average safety-adjusted liability premium per |
| | mile not insured by a gig platform for liability |
| CentsPerPhysDamMile: | Average safety-adjusted physical damage |
| | premium per mile not insured by a gig platform |
| | for physical damage |
| InsuredCarCount: | Total number of insured cars during each |
| | period |

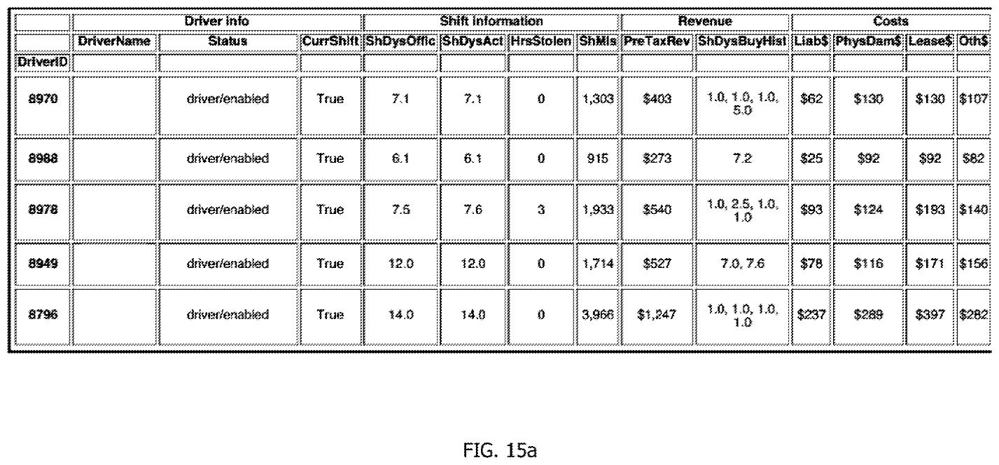

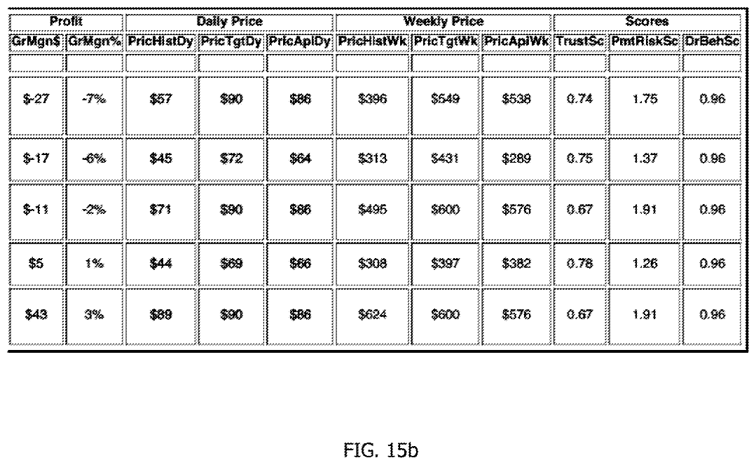

FIGS. 15a and 15b show driver economics based on mobility rental revenue, total miles driven, and costs derived from miles and hours of vehicle operation with resulting mobility vehicle rental pricing to achieve target profitability levels. For fleet owners who rent vehicles to commercial drivers with insurance included, individual driver profitability is estimated using the Dual Telemetry System and Method by applying miles driven and vehicle operating hours not only to insurance costs but also to other costs that scale with miles (e.g., maintenance) and operational hours (e.g., leasing costs). By combining all Dual Telemetry-derived costs with driver revenue, real-time mobility profitability is calculated and, as shown in FIG. 15, rental drivers can be ranked according to profitability.

The system calculates margin by combining revenue from a driver with associated costs such as that driver's insurance premiums (calculated from vehicle and commercial trip telemetry), car depreciation (calculated from vehicle miles driven by that driver), and other associated costs that are apportioned to a driver based on miles and hours of vehicle operation. Since insurance costs have significant impact on commercial-driver individual profitability and fleet owner profitability (assuming a fleet owner provides insurance), both commercial drivers and fleet owners who provide insurance coverage to their customers have an incentive to minimize miles driven that are not insured by commercial platforms and to maximize the safety with which their cars are driven during periods when vehicles are not covered by commercial platform insurance.

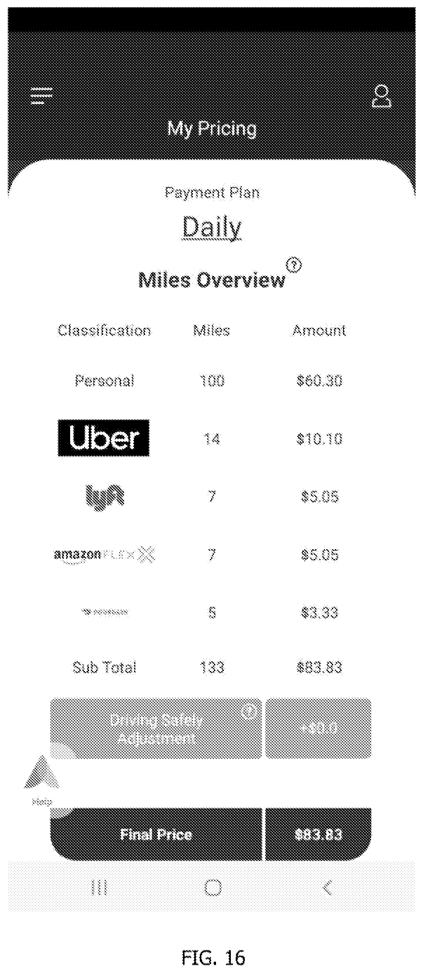

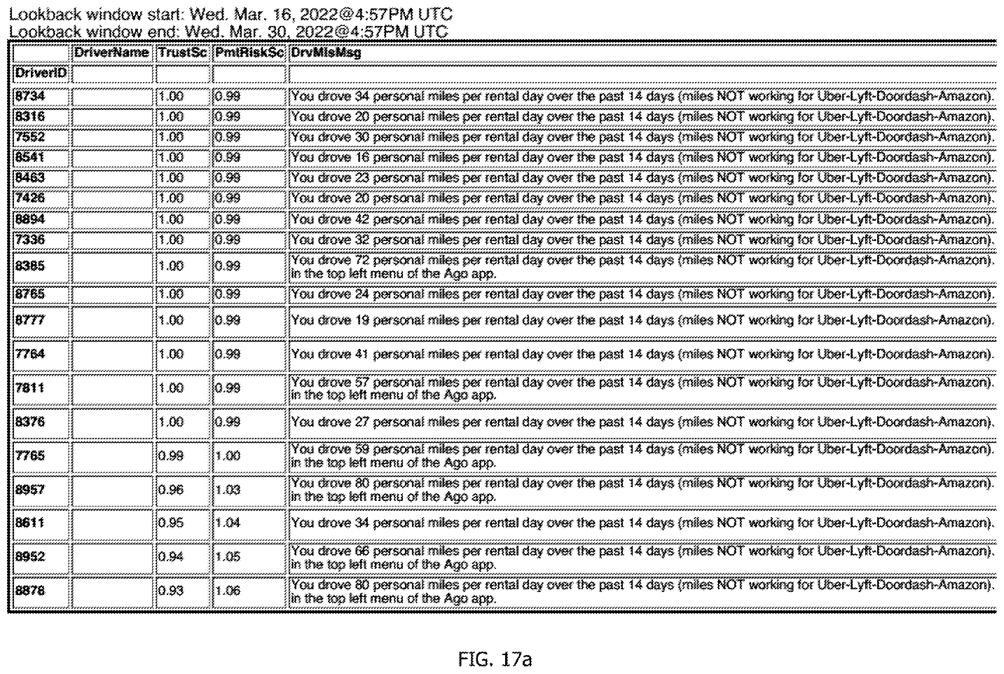

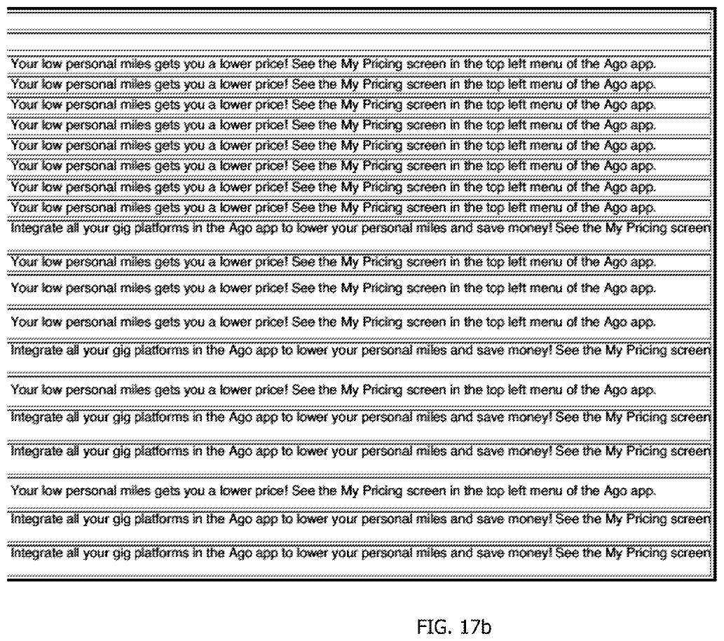

FIG. 16 shows a driver smartphone application screen that displays how mobility (i.e., vehicle rental) price is affected by commercial vs. non-commercial insured miles driven and unsafe driving behaviors. As shown in FIGS. 17a and 17b, the Integrated System and Method provides direct rental pricing signaling to drivers that shows the impact of driving commercial platform insured miles vs. non-commercial platform insured miles and unsafe driving behaviors on mobility price and thus incentivizes drivers to alter their mix of future commercial miles vs. non-commercial miles driven and to drive more safely.

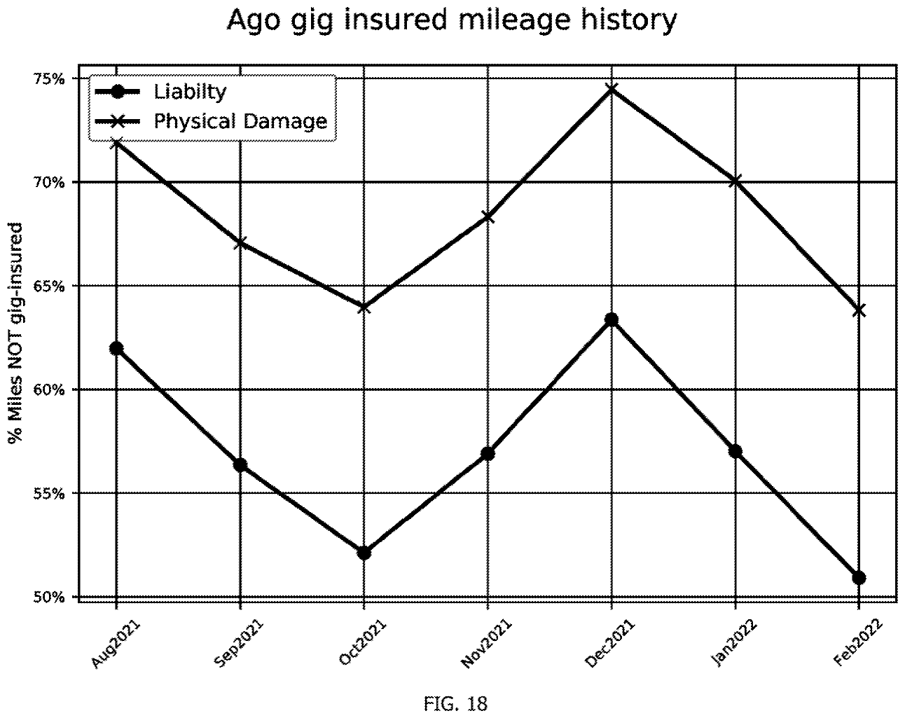

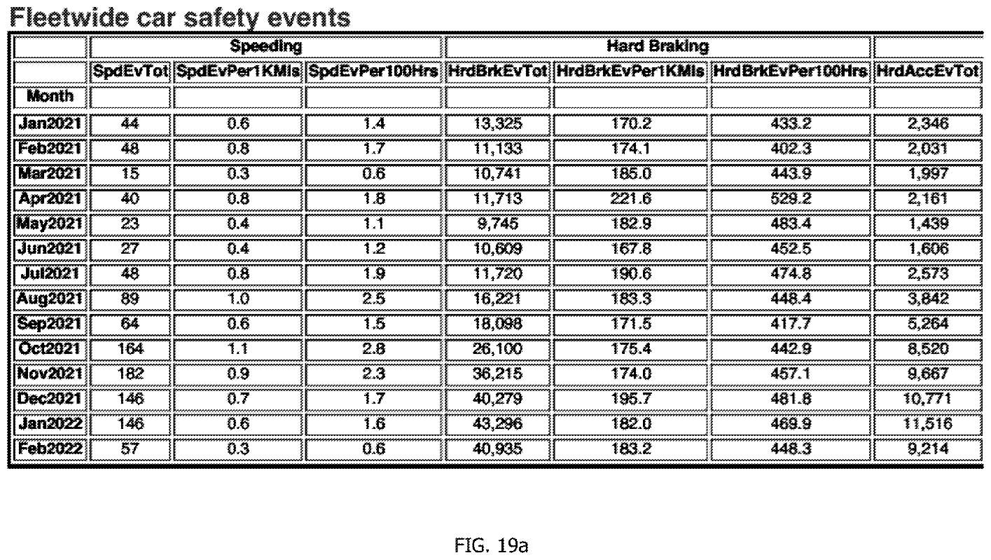

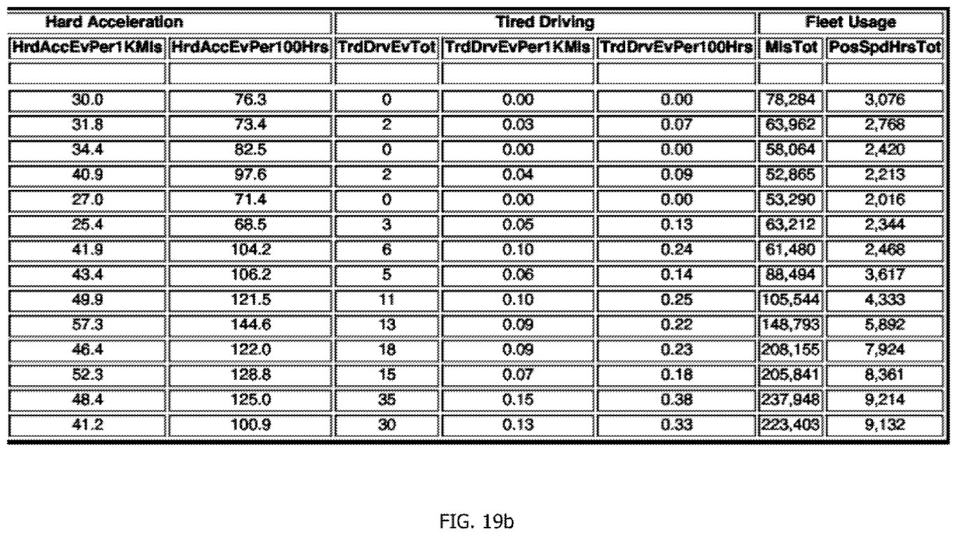

Additionally, as shown in FIGS. 17a and 17b, the Integrated System and Method directly messages drivers concerning their commercial platform insured vs. non-commercial platform insured miles with reminders that they can lower their mobility price (and insurance costs in the case of drivers buying their own insurance) by driving fewer miles not covered by commercial platform insurance. The Integrated System and Method enables tracking of commercial platform insured vs. not commercial platform insured miles at a fleetwide level as shown in FIG. 18. To further lower insurance costs, as shown in FIGS. 19a and 19b, the Integrated System and Method monitors vehicle telemetry for unsafe driving behaviors such as tired driving, speeding, hard braking, hard acceleration, and late-night driving which especially add risk for drivers and/or fleet owners during periods when a vehicle is not covered by commercial platform insurance.

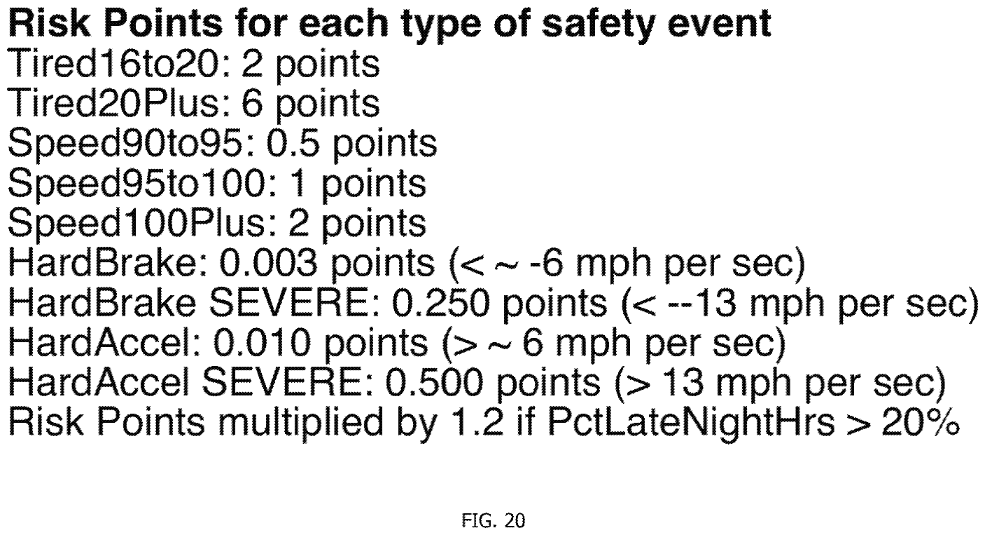

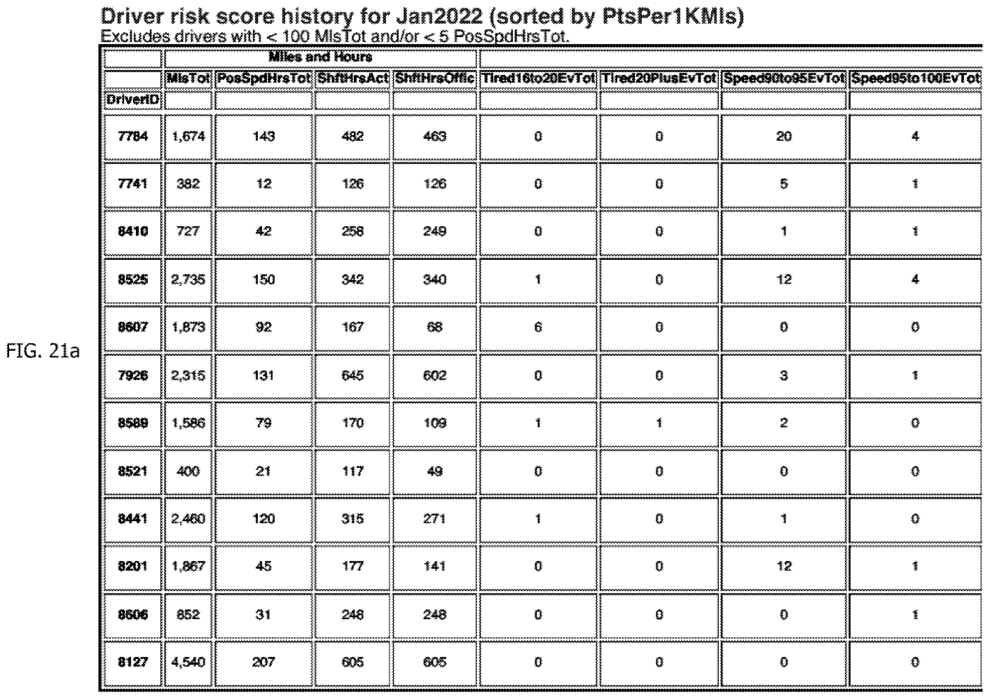

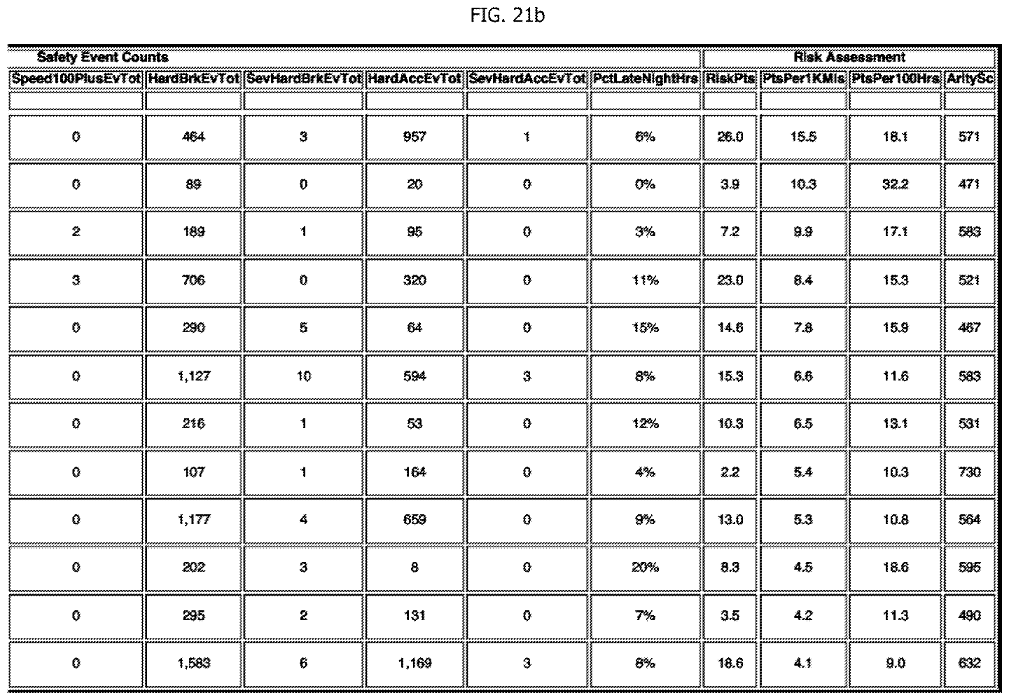

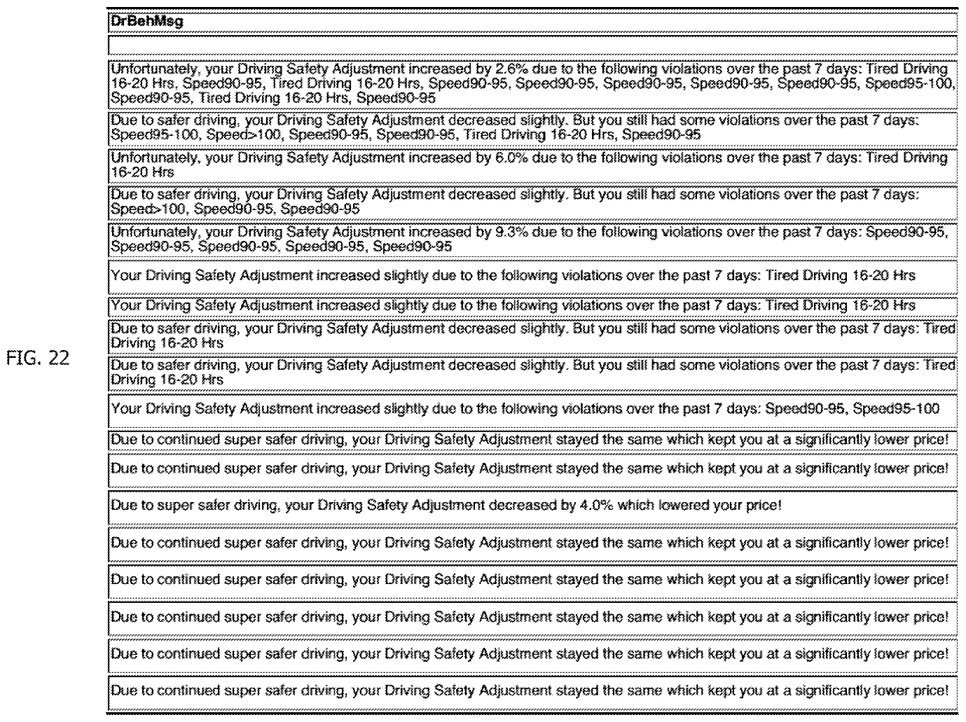

FIG. 20 shows illustrative Risk Points assigned to potentially unsafe driving behaviors. The Method then applies Risk Points to each unsafe driving behavior as illustrated in FIGS. 21a and 21b to calculate an overall driver Risk Score. The system calculates driver safety by assigning “Risk Points” to drivers where various unsafe driving events earn differing levels of Risk Points. Example risky events that earn Risk Points are speeding over 100 mph, driving without sufficient rest for more than 20 hours, severe hard braking at more than −13 mph/sec, severe acceleration at more than 13 mph/sec. Risk Points are assigned to any risky behavior believed to correlate with increased accident risk. Additional or modified unsafe driving behaviors could be added to the invention that are known in the industry. The Integrated System and Method incentivizes drivers to reduce unsafe driving behaviors by dynamically altering price as shown by the “Driving Safety Adjustment” in FIG. 16 and messages sent to drivers in real-time or after a short delay in FIG. 22 reminding them to drive more safely if they have unsafe driving events.

FIG. 21 shows a report of the number of such unsafe driving behaviors over a specified past time period. As the right hand four columns in FIG. 21 shows, the Method applies Risk Points to each unsafe driving behavior to calculate an overall driver Risk Assessment both as an absolute number of Risk Points, and as Risk Points normalized by miles driven and by vehicle operating hours. Normalized Risk Points are a superior indicator of driver safety as they show risky driving relative to the amount of driving.

FIG. 22 shows pricing messages sent to drivers citing their unsafe driving behaviors derived from vehicle telemetry analysis. The Integrated System and Method incentivizes drivers to reduce unsafe driving behaviors by dynamically altering price and messaging drivers in real-time or after a short delay reminding them to drive more safely if they have unsafe driving events.

The Integrated System and Method provides ranges of Risk Points relative to miles driven or vehicle operating hours to define levels of driving safety, such as “Super Safe”, “Safe”, “Regular”, and “Risky”. In an example, the title “Stat insignif” means that if a driver has driven too few miles or hours, there is not enough data available to draw statistically significant conclusions regarding their risky driving behaviors.

Risk Points are normalized by miles driven and vehicle operating hours. The Integrated System and Method measures median normalized Risk Points every month for a real car rental fleet. Additional data points are normalized Risk Point levels for drivers who had accidents. Drivers who had accidents tend to have normalized Risk Point levels well above the fleetwide median. Drivers who remain for a prolonged time at the “Risky” level of normalized Risk Points relative to miles driven and/or vehicle operating hours are penalized based on preset variables, such as rental price increases, insurance premium increases, and bans from future vehicle rentals.

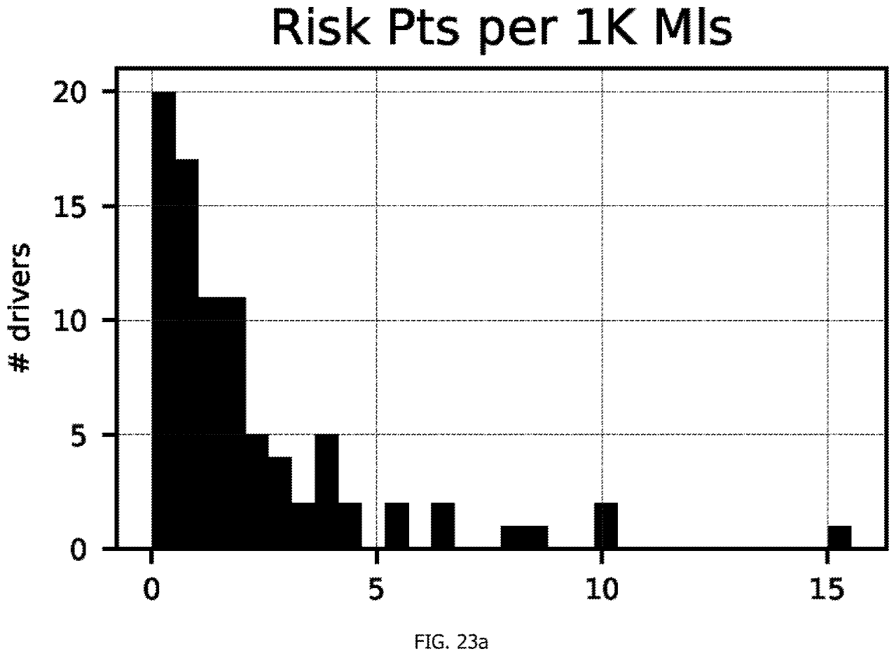

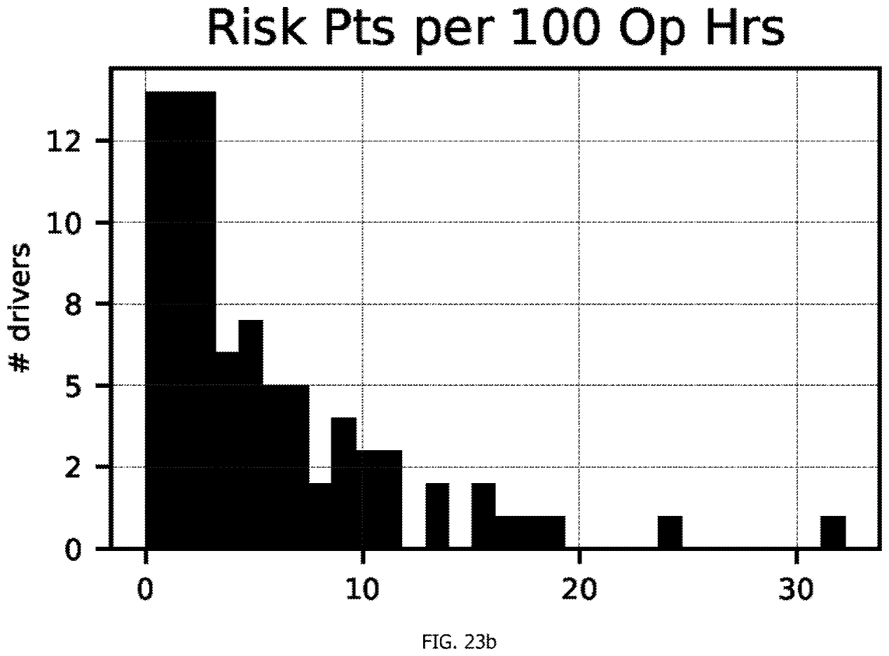

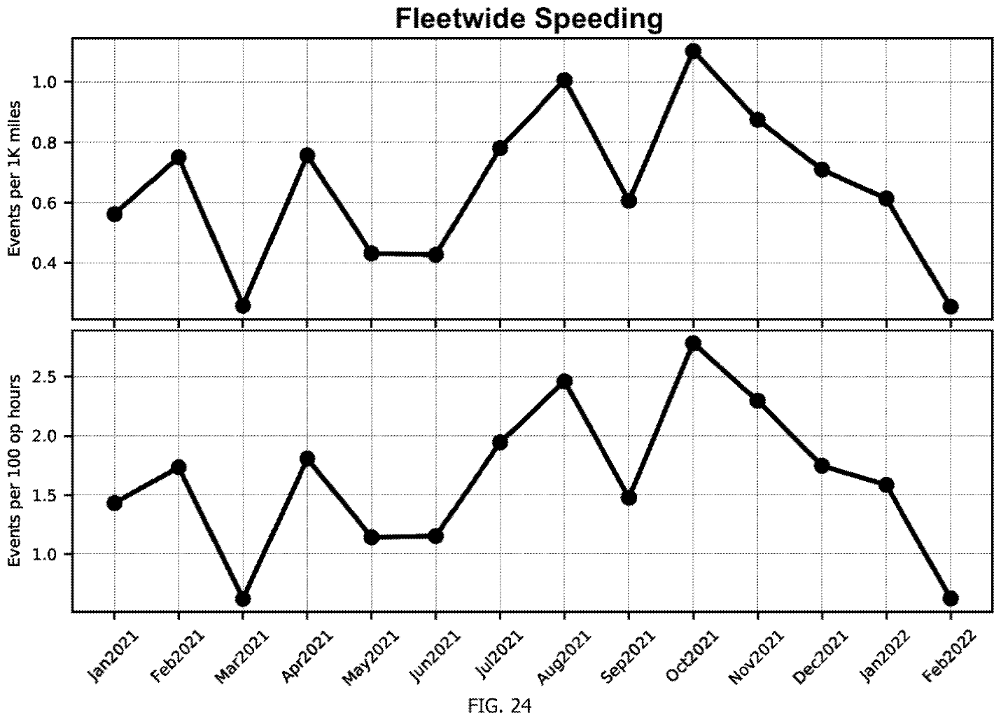

The System and Method monitors fleetwide unsafe driving behavior by analyzing the distribution of normalized Risk Points among drivers as shown in FIG. 23a (normalized by miles driven) and FIG. 23b (normalized by vehicle operating hours) and tracking fleetwide various unsafe driving behaviors over time as illustrated in FIG. 24 which tracks speeding.

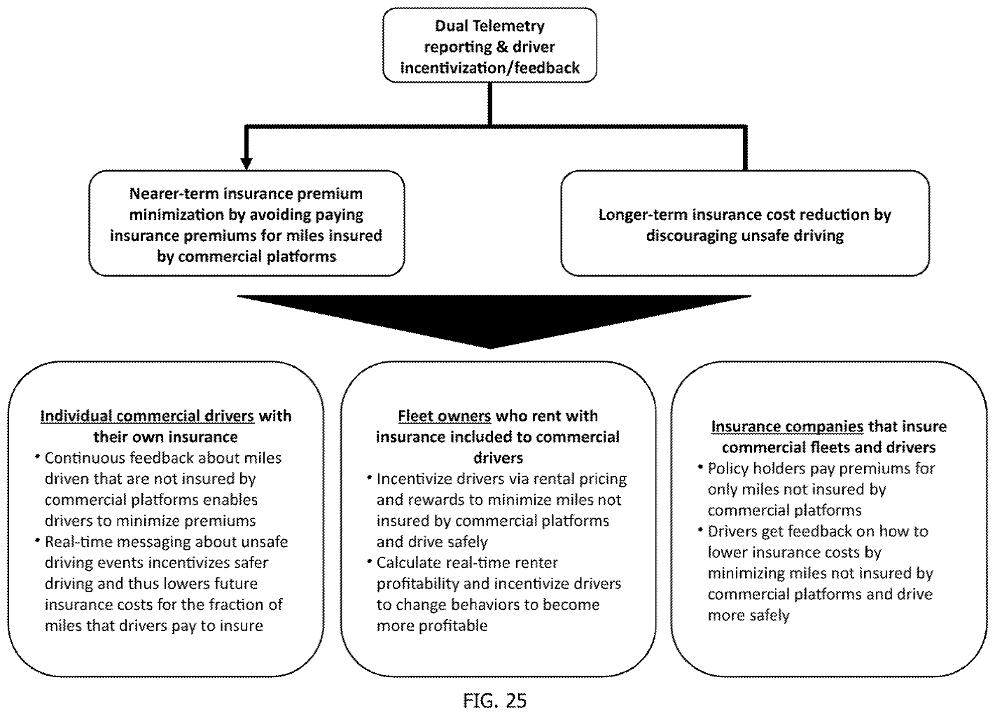

FIGS. 23a and 23b show histograms of driver Risk Points based on unsafe driving behaviors. The System and Method monitors fleetwide unsafe driving behavior by analyzing the distribution of Risk Points among drivers. In general, data shows that most drivers have low Risk Points but there are a small number of drivers with high Risk Points. FIG. 25 summarizes the Dual Telemetry value proposition and shows different types of customer beneficiaries. At the top, Dual Telemetry reporting & driver incentivization/feedback. That feeds into a) nearer-term insurance premium minimization by avoiding paying insurance premiums for miles insured by commercial platforms and b) longer-term insurance cost reduction by discouraging unsafe driving.

The benefits are three-fold. For individual commercial drivers with their own insurance, they get: a) continuous feedback about miles driven that are not insured by commercial platforms enabling drivers to minimize premiums, and b) real-time messaging about unsafe driving events to incentivize safer driving and thus lower future insurance costs for the fraction of miles that drivers pay to insure.

For fleet owners who rent with insurance included to commercial drivers: a) incentivize drivers via rental pricing and rewards to minimize miles not insured by commercial platforms and drive safely, and b) calculate real-time renter profitability and incentivize drivers to change behaviors to become more profitable.

For insurance companies that insure commercial fleets and drivers: a) policy holders pay premiums for only miles not insured by commercial platforms, and b) drivers get feedback on how to lower insurance costs by minimizing miles not insured by commercial platforms and drive more safely. While particular elements, embodiments and applications of the present invention have been shown and described, it will be understood, that the invention is not limited thereto since modifications can be made by those skilled in the art without departing from the scope of the present disclosure, particularly in light of the foregoing teachings.

Furthermore, particular elements of the present invention as described in the embodiments above can be incorporated into the Dual Telemetry System and Method To Reduce Insurance Costs and Claims in other suitable combinations or arrangements, for example, to suit particular applications.

The modules and elements of the present invention are implemented mechanically and with sensors, processors connectively associated with non-transitory computer-readable storage medium storing one or more programs that causes one or more processors or information processing apparatus to execute on one or more processes.

The examples used herein are only some embodiments of the invention. Thus, it is seen that the objects of the present invention are efficiently obtained, although modifications and changes to the invention should be readily apparent to those having ordinary skill in the art, which modifications are intended to be within the spirit and scope of the invention as claimed. It is also understood that the foregoing description is illustrative of the present invention and should not be considered as limiting. Therefore, other embodiments of the present invention are possible without departing from the spirit and scope of the present invention.

What is claimed is:

1. A dual telemetry system to reduce insurance cost and claims comprising:
a vehicle telemetry module that ingests and stores vehicle telemetry data from one or more sources;
a driver determination module that determines an identity of a driver by at least one of the following:
vehicle reservation histories; and,
tracking proximity between vehicles and driver smartphones with GPS data; and,
biometric recognition using sensors within the vehicle;
a commercial trip history module that ingests and stores driver commercial platform credentials and historical data related to vehicular telemetry during a trip period;
an estimating module that estimates vehicle miles driven during the trip period;
a processor that uses the vehicle telemetry module, the trip telemetry module, the estimating module and the driver determination module to determine commercial miles driven during the trip period;
an insurance premium processor that eliminates overlaps between sequential commercial trips of the driver to retain the most comprehensive insurance coverage from commercial platforms; and
an insurance premium processor that generates liability and physical damage insurance premiums using the commercial miles driven.

2. The system of claim 1 further comprising an insurance premium processor that generates liability and physical damage insurance premiums using the vehicle miles driven.

3. The system of claim 1 further comprising a graphic user interface showing miles driven on various commercial platforms that are insured by those commercial platforms and miles not insured by any commercial platform.

4. The system of claim 2 further comprising an insurance premium processor that generates liability and physical damage insurance premiums by comparing one or more of: commercial miles that are and are not insured for liability; commercial miles that are and are not insured for physical damages; and, vehicle miles not insured by any commercial platform.

5. The system of claim 2 further comprising a system connection status sensor that monitors commercial accounts submitted by drivers; and, for drivers with invalid commercial account connection status(es), a connection status processor prevents future mobility reservations or causes an insurance premium processor to adjust premiums.

6. The system of claim 2 further comprising an insurance premium processor that periodically adjusts premiums based upon at least one of vehicle telemetry and trip telemetry data.

7. The system of claim 6 wherein the insurance premiums are adjusted based upon a change in commercial or non-commercial platform insured miles.

8. The system of claim 6 wherein the insurance premiums are adjusted by the insurance premium processor upon unsafe driving events.

9. The system of claim 6 further comprising a generator that generates a human perceptual indication regarding at least one change in periodically adjusted premium.

10. The system of claim 6 further comprising a generator that generates a human perceptual indication as to the change in the at least one of vehicle telemetry and trip telemetry data that corresponds to the at least one change in periodically adjusted premium.

11. The system of claim 6 further comprising a generator that generates a human perceptual indication of trends in changes to driver insurance coverage due to unsafe driving behaviors.

12. The system of claim 6 further comprising an insurance processor that calculates driver profitability based on at least: revenue; total miles driven; and, insurance costs derived from miles and vehicle operation hours wherein the driver profitability is used to set insurance premiums and/or vehicle rental rates that target profitability levels for at least one of: the driver; and, a fleet.

13. The system of claim 6 further comprising a tracking mechanism of fleetwide miles driven that are not covered by commercial platform insurance and using the tracking mechanism to assess and optimize driver feedback and pricing policies to improve driver incentives to reduce miles not insured by any commercial platform.

14. The system of claim 6 further comprising a tracking mechanism that tracks fleetwide unsafe driving event history during various periods of commercial platform insurance coverage and periods of no commercial platform insurance coverage and using the tracking mechanism to assess and optimize driver feedback and pricing policies to improve driver incentives to lower insurance costs by reducing the frequency of unsafe driving events.

15. The system of claim 6 further comprising an analyzer that uses GPS-enabled map lookups based upon at least one or more of the following: trip start; trip end; and, trip paths to calculate a risk value about how one or more vehicles are used and the risk value is used by at least one of the following: a generator that generates a human perceptual indication as to the risk value; and, an insurance processor generates liability and physical damage insurance premiums using the risk value.

16. The system of claim 10 further comprising an insurance processor that generates insurance premiums for a fleet insurance policy wherein the insurance premiums are calculated to cover operations not covered by commercial platform insurance.

17. The system of claim 10 further comprising an insurance processor that generates insurance premiums for the driver wherein the insurance premiums are calculated to cover operations not covered by commercial platform insurance.

18. The system of claim 12 that ranks drivers by profitability and that prevents low-margin drivers from at least one of the following: accessing fleet assets; and reserving fleet assets.

19. The system of claim 12 that ranks drivers by unsafe driving behaviors and that prevents unsafe drivers from at least one of the following: accessing fleet assets; and reserving fleet assets.

20. A dual telemetry method to reduce insurance cost and claims comprising:
using a vehicle telemetry module to ingests and store vehicle telemetry data from one or more sources;
using a driver determination module to determines an identity of a driver by at least one of the following:
vehicle reservation histories; and,
tracking proximity between vehicles and driver smartphones with GPS data; and,
biometric recognition using sensors within the vehicle;
using a trip history module to ingests and store driver credentials and historical data related to vehicular telemetry during each a trip period;
using an estimating module that estimates vehicle miles driven during the trip period;
using a processor connectively associated with the vehicle telemetry module, the trip telemetry module, the estimating module and the driver determination module to determine commercial miles driven during the trip period;
using an insurance premium processor that eliminates overlaps between sequential commercial trips of the driver to retain the most comprehensive insurance coverage from commercial platforms; and
using an insurance premium processor that generates liability and physical damage insurance premiums using the commercial miles driven to determine how many miles were driven that were not insured for liability and/or physical damage by a commercial platform.
